(19) United States
(12) Patent Application Publication
(10) Pub. No.: US 2010/0050425 A1
(43) Pub. Date: Mar. 4, 2010

(54) ROTARY POSITIONING MECHANISM

(75) Inventors: Ping Ji, Shanhai City (CN); Chih-Feng Chen, Taipei City (TW)

Correspondence Address: EDWARDS ANGELL PALMER & DODGE LLP, P.O. BOX 55874, BOSTON, MA, 02205, US

(73) Assignee: INVENTEC CORPORATION, Taipei City (TW)

(21) Appl. No.: 12/465,888

(22) Filed: May 14, 2009

(30) Foreign Application Priority Data
Aug. 29, 2008 (CN) 200810146767.X

(51) Int. Cl. B23P 19/00

(52) U.S. Cl. 29/739

(57) ABSTRACT

A rotary positioning mechanism used for positioning a circuit board to a bottom plate of a chassis is disclosed, which has a plurality of positioning holes concentrically formed on the circuit board and a plurality of positioning columns disposed on the bottom plate of the chassis corresponding to the positioning holes respectively. Each of the positioning holes has an inserting portion and a positioning portion, and each of the positioning columns has a head portion capable of passing through the inserting portion of the corresponding positioning hole and a neck portion connected to the head portion and capable of engaging with the positioning portion of the corresponding positioning hole. By rotating the circuit board relative to the bottom plate of the chassis, the neck portion of each of the positioning columns is engaged with the positioning portion of the corresponding positioning hole, thereby positioning the circuit board to the bottom plate of the chassis.

### BACKGROUND OF THE INVENTION

1. Field of the Invention

The present invention relates generally to rotary positioning techniques, and more particularly to a rotary positioning mechanism for positioning a circuit board to a bottom plate of a chassis.

2. Description of Related Art

In a variety of products, elements need to be relatively positioned. A conventional positioning method is screwing. Although the screwing method achieves a certain positioning effect, it often needs tools for assembling and disassembling. In addition, tools, screws and nuts need to be carefully stored, which thus complicates the fabricating operation.

Accordingly, Taiwan Patent Certification Nos. I282721 and M304190 disclose a positioning technique that eliminates the need of any tools, wherein positioning columns are disposed on a bottom plate of a chassis, and gourd-shaped holes are formed on a circuit board. By moving linearly for engaging the positioning columns with the gourd-shaped holes, the circuit board is positioned to the bottom plate of the chassis.

However, in such a conventional method, the linear force applied to the elements is rather concentrated, which can easily damage the elements. In addition, when a force in a reverse direction compared to the direction for positioning is applied to the circuit board, the positioning columns can easily detach from the gourd-shaped holes, thereby causing detachment of the circuit board from the bottom plate of the chassis.

Therefore, there is a need to develop a positioning technique so as to overcome the above drawbacks.

### SUMMARY OF THE INVENTION

According to the above drawbacks, one embodiment of the present invention is to provide a rotary positioning mechanism so as to enhance the positioning effect without damage of the elements resulting from applied forces.

Another embodiment of the present invention is to provide a rotary positioning mechanism so as to enable quick and simple assembling and disassembling of a circuit board.

In order to attain the above and other embodiments, the present invention provides a rotary positioning mechanism for positioning a circuit board to a bottom plate of a chassis. In one embodiment, a plurality of positioning holes are distributed along concentric circles on the circuit board, wherein each of the positioning holes has an inserting portion and a positioning portion communicating with the inserting portion, and an inner diameter of the positioning portion is smaller than that of the inserting portion. Further, a plurality of positioning columns are disposed on the bottom plate of the chassis corresponding to the plurality of positioning holes respectively, wherein each of the plurality of positioning columns has a head portion for passing through the inserting portion of the corresponding positioning hole and a neck portion connected to the head portion for engaging with the positioning portion of the corresponding positioning hole. Also, an outer diameter of the neck portion is smaller than that of the head portion, and the positioning portion of each of the plurality of positioning holes is located at a same rotation direction as the inserting portion of each of the plurality of positioning holes. In other words, when the circuit board is rotated counter-clockwise or clockwise relative to the bottom plate of the chassis, the positioning portion of each of the plurality of positioning holes extends from the inserting portion of each of the plurality of the positioning holes along a direction in contrast to the rotation direction along the concentric circles. As a result, by rotating the circuit board relative to the bottom plate of the chassis, the circuit board can be engaged with the bottom plate of the chassis. In addition, an engaging portion is disposed on one side of the bottom plate of the chassis. When the circuit board is rotated relative to the bottom plate of the chassis, one edge of the circuit board is engaged with the engaging portion so as to rotarily position the circuit board to the bottom plate of the chassis.

The above rotary positioning mechanism further comprises a central hole formed at a position of a circle center of at least a concentric circle. At least a positioning hole is respectively formed along the at least a concentric circle with different distances from the central hole, and the at least a positioning hole is formed in a gourd shape.

Preferably, a central column is disposed on the bottom plate of the chassis and corresponds to the central hole. The positioning portion of each of the at least a positioning hole is an arc-shaped opening along the corresponding concentric circle. The smaller the diameter of the concentric circle is, the shorter the length of the positioning portion is. In one embodiment, the engaging portion is an elastic hook, which is engaged with the circuit board for providing an assisting positioning effect.

According to the present invention, a plurality of positioning columns disposed on the bottom plate of the chassis is first inserted into the corresponding positioning holes concentrically distributed on the circuit board, and then the circuit board is rotated relative to the bottom plate of the chassis so as to make the positioning columns to engage with the positioning portions of the positioning holes, thereby positioning the circuit board to the bottom plate of the chassis. Further, the engagement of the engaging portion on the bottom plate with the circuit board provides an assisting positioning effect, which prevents detachment of the circuit board from the bottom plate of the chassis when a force in a direction reverse to the rotation direction for positioning is applied to the circuit board. Therefore, the present invention eliminates the need of any tools, enhances the positioning effect, protects the elements from being damaged by applied forces, and enables quick and simple assembling and disassembling of the circuit board, thereby overcoming the drawbacks of the prior art.

### BRIEF DESCRIPTION OF DRAWINGS

FIG. 1 is an exploded view of a rotary positioning mechanism according to one embodiment of the present invention;

FIG. 2A is an exploded top view of the rotary positioning mechanism with the positioning columns inserted into the inserting portions of the corresponding positioning holes;

FIG. 2B is an exploded top view of the rotary positioning mechanism with the positioning columns engaged with the positioning portions of the corresponding positioning holes after rotation of the circuit board;

FIG. 3 is an exploded view of a rotary positioning mechanism according to another embodiment of the present invention; and

FIG. 4 is an exploded view of a rotary positioning mechanism according to still another embodiment of the present invention.

### DETAILED DESCRIPTION OF PREFERRED EMBODIMENTS

The following illustrative embodiments are provided to illustrate the disclosure of the present invention. These and other advantages and effects can be apparent to those skilled in the art after reading the disclosure of this specification.

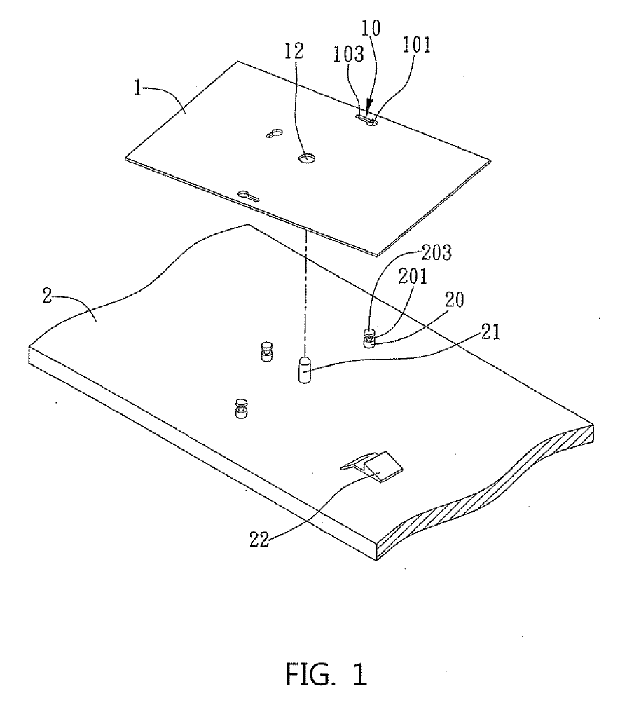

FIG. 1 is an exploded view of a rotary positioning mechanism according to one embodiment of the present invention. A chassis has a bottom plate 2 for placing the circuit board 1. The circuit board 1 may be such as a main board, and the chassis may be a chassis of an electronic device such as a server. It should be noted that the drawings only show basic structure of the present invention and do not intend to limit the present invention.

As shown in FIG. 1, the rotary positioning mechanism comprises a plurality of positioning holes 10 formed on the circuit board 1 and a plurality of positioning columns 20 disposed on the bottom plate 2 of the chassis. The rotary positioning mechanism is used for positioning the circuit board 1 to the bottom plate 2 of the chassis through rotation of the circuit board 1 relative to the bottom plate 2 of the chassis. However, it should be noted that the present invention can be used for positioning any related component to the chassis of an electronic device and is not limited thereto.

The plurality of positioning holes 10 are concentrically formed on the circuit board 1 with predetermined distances from a circle center. The predetermined distances may be varied according to the practical need. In the present embodiment, the positioning holes 10 are formed along concentric circles with different radii. In other embodiments, at least a positioning hole 10 may be formed along the same circle.

Further, in the present embodiment, the positioning holes 10 have a gourd shape. Each of the positioning holes 10 has an inserting portion 101 and a positioning portion 103 communicating with the inserting portion 101. Also, the positioning portion 103 of each of the positioning holes 10 is formed corresponding to the inserting portion 101 of each of the positioning holes 10. In other words, the positioning portion 103 and the inserting portion 101 of each of the positioning holes 10 are arranged in a same direction along a corresponding concentric circle. In addition, an inner diameter of the positioning portion 103 is smaller than that of the inserting portion 101. Preferably, the smaller the diameter of the concentric circle is, the shorter the length of the positioning portion 103 is. In one preferred embodiment, the positioning portion of each of the plurality of positioning holes extends from the inserting portion of each of the plurality of the positioning holes along a direction in contrast to the rotation direction along the concentric circles when the circuit board is rotated at a counter-clockwise direction or at a clockwise direction around the bottom plate 2 of the chassis for positioning.

A plurality of positioning columns 20 are disposed on the bottom plate 2 of the chassis and correspond to the positioning holes 10, respectively. Each of the positioning columns 20 has a head portion 203 capable of passing through the inserting portion 101 of the corresponding positioning hole 10 and a neck portion 201 connected to the head portion 203 and capable of engaging with the positioning portion 103 of the corresponding positioning hole 10. Accordingly, by rotating the circuit board 1 relative to the bottom plate 2 of the chassis around the circle center, the circuit board 1 can be positioned to the bottom plate 2 of the chassis. In the present embodiment, the neck portion 201 of each of the positioning columns 20 has a relatively smaller outer diameter than that of the head portion 203, and the size of the head portion 203 of each of the positioning columns 20 is sufficient for the head portion 203 to pass through the inserting portion 101 of the corresponding positioning hole 10. Further, by rotating the circuit board 1 relative to the bottom plate 2 of the chassis, the neck portion 201 of each of the positioning columns 20 can be engaged with the positioning portion 103 of the corresponding position hole 10. In the present embodiment, there are three positioning holes 10 and three corresponding positioning columns 20. In other embodiments, the number and positions of the positioning holes 10 and corresponding positioning columns 20 can be varied and are not limited to the present embodiment.

In the present embodiment, the circle center of the concentric circles is close to the geometric center of the circuit board 1, and a central hole 12 is formed at a position of a circle center of the concentric circles on the circuit board 1. Correspondingly, a central column 21 is disposed on the bottom plate 2 of the chassis corresponding to the central hole 12. While positioning the circuit board 1 to the bottom plate 2 of the chassis, the central column 21 is inserted into the central hole 12 so as to provide a preliminary positioning effect. Further, the central hole 12 provides support for the circuit board 1 so as to facilitate subsequent insertion of the positioning columns 20 into the corresponding positioning holes 10. As shown in FIG. 1, in the present embodiment, the positioning portion 103 of each of the positioning holes 10 is an arc-shaped opening, which for example has a length greater than that of the inserting portion 101, thereby providing an arc-shaped rotation path for the circuit board 1. The degree of curvature of the arc shape can be varied according to the practical need. The more similar the curvature of the arc shape to the circular path of the circle center, the easier the neck portion of the positioning column is engaged with the positioning portion of the corresponding positioning hole.

Further, in the present embodiment, an engaging portion 22, which can be an elastic hook, is disposed on the bottom plate 2 of the chassis for engaging with the circuit board 1. After the neck portions 201 of the positioning columns 20 are engaged with the positioning portions 103 of the corresponding positioning holes 10, the engaging portion 22 bounces up and engages with one edge of the circuit board 1 so as to prevent disengagement of the positioning columns 20 from the positioning portions 103 of the positioning holes 10 when a force in a direction reverse to the rotation direction for positioning is applied to the circuit board 1, thereby providing an assisting positioning effect and safely fixing the circuit board 1 to the bottom plate 2 of the chassis.

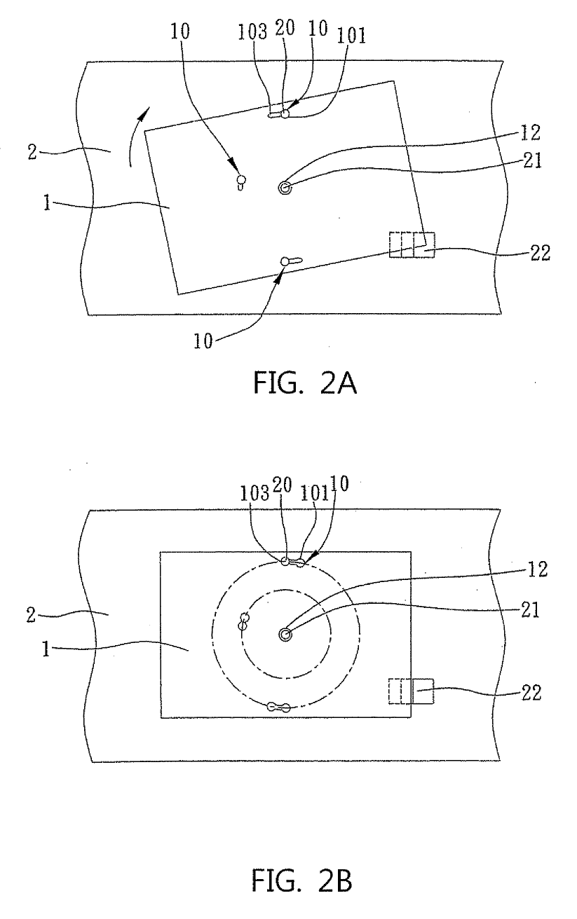

FIG. 2A is an exploded top view of the rotary positioning mechanism with the positioning columns inserted into the inserting portions of the positioning holes, and FIG. 2B is an exploded top view of the rotary positioning mechanism with the positioning columns engaged with the positioning portions of the positioning holes after rotation of the circuit board.

In the present embodiment, while positioning the circuit board 1 to the bottom plate 2 of the chassis, the central column 21 and the positioning columns 20 on the bottom plate 2 of the chassis are respectively passed through the central hole 12 and the positioning holes 10 on the circuit board. Then, the circuit board 1 is rotated clockwise such that the neck portion 201 of each of the positioning columns 20 is engaged with the positioning portion 103 of the corresponding positioning hole 10. Also, one edge of the circuit board 1 is engaged with the engaging portion 22 on the bottom plate 2 of the chassis for preventing detachment of the circuit board 1 from the bottom plate 2. On the other hand, in order to disassemble the circuit board 1 from the bottom plate 2, it only needs to gently press down the engaging portion 22 to disengage the circuit board 1 from the engaging portion 22 and then rotate the circuit board 1 counter-clockwise, which is a quite easy operation.

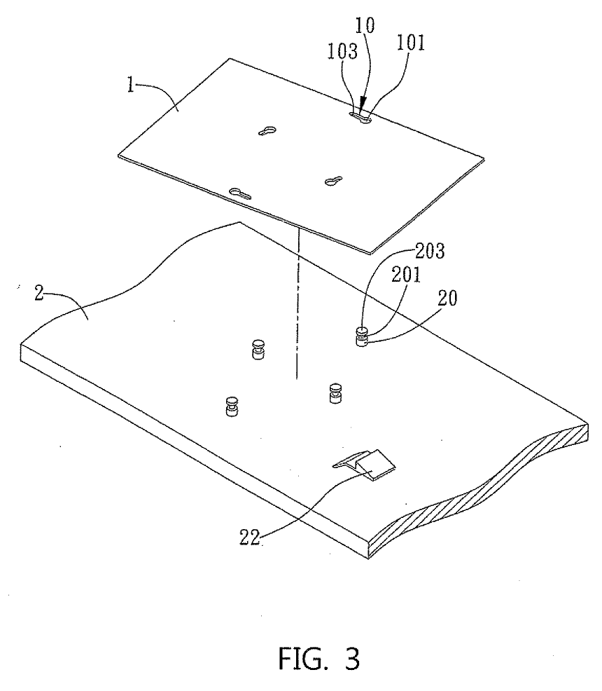

FIG. 3 is an exploded view of a rotary positioning mechanism according to another embodiment of the present invention, wherein a plurality of positioning holes 10 are concentrically formed on the circuit board 1 with predetermined distances from the circle center. The predetermined distances can be varied according to the practical need. Further, each of the positioning holes 10 has an inserting portion 101 and a positioning portion 103 communicating with the inserting portion 101, and the positioning portion 103 of each of the positioning holes 10 is located at a same rotation direction as the inserting portion 101 of each of the positioning holes 10. Different from the previous embodiment, the central hole 12 as shown in FIG. 1 is not formed on the circuit board 1 in the present embodiment. The positioning holes 10 of the present embodiment have a gourd shape, and the number of the positioning holes is at least two. In one preferred embodiment, the positioning portion of each of the positioning holes extends from the inserting portion of each of the positioning holes along a direction in contrast to the rotation direction along the concentric circles when the circuit board is rotated at a counter-clockwise direction or a clockwise direction around the bottom plate 2 of the chassis for positioning.

A plurality of positioning columns 20 are disposed on the bottom plate 2 of the chassis and correspond to the positioning holes 10 on the circuit board, respectively. Each of the positioning columns 20 has a head portion 203 capable of passing through the insertion portion 101 of the corresponding positioning hole 10 and a neck portion 201 connected to the head portion 203 and capable of engaging with the positioning portion 103 of the corresponding positioning hole 10. Accordingly, by rotating the circuit board 1 relative to the bottom plate 2 of the chassis around the circle center, the circuit board 1 can be positioned to the bottom plate 2. Different from the previous embodiment, no central column 21 as shown in FIG. 1 is disposed on the bottom plate 2 of the chassis.

In the present embodiment, in order to position the circuit board 1 to the bottom plate 2 of the chassis, the plurality of the positioning columns 20 are passed through the corresponding positioning holes 10 respectively, and the circuit board 1 is then rotated clockwise such that the neck portion 201 of each of the positioning columns 20 can be engaged with the positioning portion 103 of the corresponding positioning hole 10. Also, one edge of the circuit board 1 is engaged with the engaging portion 22 of the bottom plate 2 so as to prevent detachment of the circuit board 1 from the bottom plate 2 of the chassis. On the other hand, in order to disassemble the circuit board 1 from the bottom plate 2, it only needs to gently press down the engaging portion 22 to disengage the circuit board 1 from the engaging portion 22 and then rotate the circuit board 1 counter-clockwise, which can achieve the effect of positioning the circuit board 1 to the bottom plate 2 of the chassis.

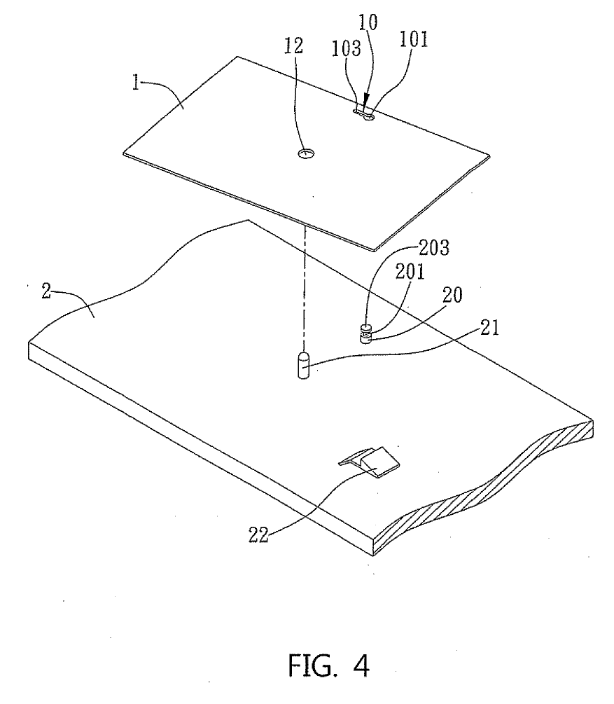

FIG. 4 is an exploded view of a rotary positioning mechanism according to still another embodiment of the present invention. In the present embodiment, a positioning hole 10 and a central hole 12 are formed on the circuit board 1, and a positioning column 20 and a central column 21 are correspondingly disposed on the bottom plate 2 of the chassis. In the present embodiment, the number of the positioning holes is one. Further, the positioning hole 10 has an inserting portion 101 and a positioning portion 103 communicating with the inserting portion 101, and the positioning portion of the positioning hole is located at a same rotation direction as the inserting portion of the positioning hole. In one preferred embodiment, the positioning portion of the positioning hole extends from the inserting portion of the positioning hole along a direction in contrast to the rotation direction along the concentric circle when the circuit board is rotated at a counter-clockwise direction or a clockwise direction around the bottom plate 2 of the chassis for positioning.

In the present embodiment, while positioning the circuit board 1 to the bottom plate 2 of the chassis, the central column 21 and the positioning column 20 are respectively passed through the central hole 12 and the positioning hole 10, and then the circuit board 1 is rotated clockwise such that the neck portion 201 of the positioning column 20 can be engaged with the positioning portion 103 of the positioning hole 10. Also, one edge of the circuit board 1 is engaged with the engaging portion 22 of the bottom plate 2 so as to prevent detachment of the circuit board 1 from the bottom plate 2 of the chassis. On the other hand, in order to disassemble the circuit board 1 from the bottom plate 2, it only needs to gently press down the engaging portion 22 to disengage the circuit board 1 from the engaging portion 22 and then rotate the circuit board 1 counter-clockwise, which can also achieve the effect of positioning the circuit board 1 to the bottom plate 2 of the chassis.

In particular, the circuit board 1 is positioned to the bottom plate 2 of the chassis by forces in multiple directions, which prevent linear movement of the circuit board 1. Therefore, even if a linear force is applied to the circuit board 1, the circuit board 1 will not be separated or detached from the bottom plate 2 of the chassis, so as to safely position the circuit board 1 to the bottom plate 2.

Further, in the aforementioned embodiments, after the neck portion 201 of each of the positioning columns 20 on the bottom plate 2 of the chassis is engaged with the positioning portion 103 of the corresponding positioning hole 10 on the circuit board 1 through rotation of the circuit board 1 relative to the bottom plate 2 of the chassis, the circuit board 1 can be engaged with the engaging portion 22 on the bottom plate 2 of the chassis for enhancing the positioning effect of the circuit board 1 to the bottom plate 2 of the chassis. At least a positioning hole 10 is distributed on the circuit board 1 along at least a concentric circle having a predetermined distance from a circle center. The predetermined distance may be varied according to the practical need. Since a central hole 12 is formed at a position of a circle center of the at least a concentric circle on the circuit board 1 and a central column 21 is disposed on the bottom plate 2 of the chassis corresponding to the central hole 12, the central column 21 can be inserted into the central hole 12 so as to provide a preliminary positioning effect and further support for the circuit board 1 to facilitate subsequent insertion of the positioning columns 20 into the inserting portions 101 of the corresponding positioning holes 10.

Further, the path for the positioning column 20 to move from the inserting portion 101 of the positioning hole 10 to the positioning portion 103 of the positioning hole 10 is in an arc shape so as to allow the circuit board 1 to rotate in an arc-shaped path.

It should be noted that the rotation direction of the circuit board 1 relative to the bottom plate 2 of the chassis for positioning can be changed according to the relative positions of the inserting portion 101 and the positioning portion 103 of each of the positioning holes 10. In other words, the positioning portion of each of the positioning holes can extend from the inserting portion of each of the positioning holes along a direction in contrast to the rotation direction along the concentric circles when the circuit board is rotated at a counter-clockwise direction or a clockwise direction around the bottom plate of the chassis for positioning. Since it is well understood by those skilled in the art, detailed description thereof is omitted.

According to the present invention, a plurality of positioning columns disposed on the bottom plate of the chassis is first inserted into the corresponding positioning holes concentrically distributed on the circuit board, and then the circuit board is rotated relative to the bottom plate of the chassis so as to make each of the positioning columns to engage with the positioning portion of each of the positioning holes, thereby positioning the circuit board to the bottom plate of the chassis. Accordingly, the present invention overcomes the problem of detachment of the circuit board from the bottom plate of the chassis caused by the conventional linear engagement between positioning columns and positioning holes. Further, the engagement between the circuit board and the engaging portion on the bottom plate of the chassis provides an assisting positioning effect, which prevents detachment of the circuit board from the bottom plate when a force in a direction reverse to the rotation direction for positioning is applied to the circuit board. Therefore, the present invention eliminates the need of any tools, enhances the positioning effect, protects the elements from being damaged by applied forces, and enables quick and simple assembling and disassembling of the circuit board, thereby overcoming the drawbacks of the prior art.

The aforementioned descriptions of the detailed embodiments are only to illustrate the preferred implementation according to the present invention and do not intend to limit the scope of the present invention. Accordingly, all modifications and variations completed by those of ordinary skills in the art should fall within the scope of the present invention defined by the appended claims.

What is claimed is:

1. A rotary positioning mechanism, comprising:
a plurality of positioning holes distributed along concentric circles on a circuit board, wherein each of the plurality of positioning holes has an inserting portion and a positioning portion communicating with the inserting portion, and an inner diameter of the positioning portion is smaller than that of the inserting portion;
a plurality of positioning columns disposed on a bottom plate of a chassis corresponding to the plurality of positioning holes respectively, wherein each of the plurality of positioning columns has a head portion for passing through the inserting portion of the corresponding positioning hole and a neck portion connected to the head portion for engaging with the positioning portion of the corresponding positioning hole, an outer diameter of the neck portion is smaller than that of the head portion, and the positioning portion of each of the plurality of positioning holes is located at a same rotation direction as the inserting portion of each of the plurality of positioning holes; and
an engaging portion disposed on one side of the bottom plate of the chassis for engaging with one edge of the circuit board so as to rotarily position the circuit board to the bottom plate of the chassis.

2. The rotary positioning mechanism of claim 1, wherein the positioning portion of each of the plurality of positioning holes extends from the inserting portion along a direction in contrast to the rotation direction along the concentric circles.

3. The rotary positioning mechanism of claim 2, wherein the circuit board is rotated at a counter-clockwise direction or a clockwise direction around the bottom plate of the chassis for positioning.

4. The rotary positioning mechanism of claim 1, wherein each positioning hole has a gourd shape and the number of the plurality of positioning holes is at least two.

5. The rotary positioning mechanism of claim 1, wherein the positioning portion of each of the plurality of positioning holes is an arc-shaped opening along the corresponding concentric circle.

6. The rotary positioning mechanism of claim 1, wherein the smaller the diameter of the concentric circle is, the shorter the length of the positioning portion is.

7. The rotary positioning mechanism of claim 1, wherein the engaging portion is an elastic hook.

8. A rotary positioning mechanism, comprising:
at least a positioning hole distributed along at least a concentric circle on a circuit board, wherein a central hole is formed at a position of a circle center of the at least a concentric circle, each of the at least a positioning hole has an inserting portion and a positioning portion communicating with the inserting portion, and an inner diameter of the positioning portion is smaller than that of the inserting portion;
at least a positioning column disposed on a bottom plate of a chassis corresponding to the at least a positioning hole respectively, wherein a central column is disposed on the bottom plate of the chassis corresponding to the central hole, each of the at least a positioning column has a head portion for passing through the inserting portion of the corresponding at least a positioning hole and a neck portion connected to the head portion for engaging with the positioning portion of the corresponding at least a positioning hole, an outer diameter of the neck portion is smaller than that of the head portion, and the positioning portion of the at least a positioning hole is located at a same rotation direction as the inserting portion of the at least a positioning hole; and
an engaging portion disposed on one side of the bottom plate of the chassis for engaging with one edge of the circuit board so as to rotarily position the circuit board to the bottom plate of the chassis.

9. The rotary positioning mechanism of claim 8, wherein the positioning portion of each of the at least a positioning hole extends from the inserting portion along a direction in contrast to the rotation direction along the at least a concentric circle.

10. The rotary positioning mechanism of claim 9, wherein the circuit board is rotated at a counter-clockwise direction or a clockwise direction around the bottom plate of the chassis for positioning.

11. The rotary positioning mechanism of claim 8, wherein the at least a positioning hole is formed in a gourd shape and the number of the at least a positioning hole is one.

12. The rotary positioning mechanism of claim 8, wherein the positioning portion of each of the at least a positioning hole is an arc-shaped opening along the corresponding at least a concentric circle.

13. The rotary positioning mechanism of claim 8, wherein the smaller the diameter of the at least a concentric circle is, the shorter the length of the positioning portion is.

14. The rotary positioning mechanism of claim 8, wherein the engaging portion is an elastic hook.
